(19) United States
(12) Patent Application Publication
(10) Pub. No.: US 2018/0257539 A1
(43) Pub. Date: Sep. 13, 2018

(54) VEHICLE OPERATION DEVICE

(71) Applicant: KABUSHIKI KAISHA TOKAI RIKA DENKI SEISAKUSHO, Aichi (JP)

(72) Inventors: Yoshiaki NABE, Aichi (JP); Susumu MEGA, Aichi (JP)

(73) Assignee: KABUSHIKI KAISHA TOKAI RIKA DENKI SEISAKUSHO, Aichi (JP)

(21) Appl. No.: 15/534,416

(22) PCT Filed: Nov. 25, 2015
(86) PCT No.: PCT/JP2015/083018

§ 371 Date: Jun. 8, 2017

(30) Foreign Application Priority Data
Dec. 15, 2014 (JP) 2014-252785

(51) Int. Cl. B60Q 1/00; B62D 1/04; B60R 16/027

(52) U.S. Cl. CPC B60Q 1/0082; B62D 1/046; H01H 19/14; B60K 2350/928; B60R 16/027

(57) ABSTRACT

A vehicle operation device includes an operation portion mounted on a predetermined portion of a steering wheel, the operation portion allowing a switching operation to be performed by a tilt operation. When the operation portion is in an on state of the switching operation, a portion of the operation portion projects from a front surface and a back surface of the steering wheel.

### TECHNICAL FIELD

The present invention relates to an operation device for a vehicle.

### BACKGROUND ART

Input devices for vehicles provided with a plurality of switches on the spokes of the steering wheel of a vehicle are known (see Patent Document 1, for example). Such input devices for vehicles include selection switches and function switches. Selection switches are used to select one mode from a preset plurality of modes. A toggle switch capable of being switched in the up-down direction by tilting the knob either up or down may be employed as the selection switch. Function switches are assigned different functions depending on the mode. Examples of modes include an audio mode, an air conditioning mode, a navigation mode, a cruise control mode, and the like. An installed cruise control device may include the function of automatically controlling acceleration and deceleration of the vehicle depending on the distance from it to a vehicle detected to the front by a radar or the like, or simply the function of maintaining the vehicle at a certain speed.

The function switches described in Patent Document 1 have different shapes depending on where the switches are disposed. Thus, the user can easily distinguish between a plurality of function switches by touching the function switch (without looking). Also, these switches have different methods of use and thus operate differently. This is to prevent a mistake in the operation of the function switches. Note that in Patent Document 1, the function switches preferably differ in shape and method of use, and in one embodiment, a rocker switch is used instead of a push switch.

### CITATION LIST

### Patent Document

Patent Document 1: Japanese Unexamined Patent Application Publication No. 2008-68673A

### SUMMARY OF INVENTION

### Technical Problem

According to the operation device for a vehicle of Patent Document 1, the function switches have different shapes depending on where the switches are disposed so that the user can easily distinguish a switch from a plurality of function switches. However, Patent Document 1 has not described nor suggested as to how the operational state of the function switches can be perceived via touch or sight. In particular, when the function switch is used in cruise control mode, it is important to be able to easily discern the operational state such as the on/off state of the function switch easily via touch or sight. Also, such demands can be expected to be raised for autonomous vehicles in the future.

An object of the present invention is to provide a vehicle operation device for which the operational state such as the on/off state of a switch function can be easily discerned via touch or sight.

### Solution to Problem

(1) A vehicle operation device according to an embodiment of the present invention includes an operation portion mounted on a predetermined portion of a steering wheel. The operation portion is switchable via a tilt operation. When the operation portion is in a switched on state, a portion of the operation portion projects from a front surface of the steering wheel and a portion projects from a back surface of the steering wheel.

(2) The embodiment described in (1) may have a configuration wherein the predetermined portion includes a spoke portion of the steering wheel; the front surface includes a front surface of the spoke portion; and the back surface includes a back surface of the spoke portion.

(3) The embodiment described in (1) or (2) may have a configuration wherein, when the operation portion is in a switched off state, the operation portion does not project from the front surface or the back surface of the steering wheel.

(4) The embodiment described in any one of (1) to (3) may have a configuration wherein, the operation portion is housed in a housing; and the housing is housed and mounted in an attachment hole portion in the steering wheel, the attachment hole portion being a through-hole from the front surface to the back surface.

(5) The embodiment described in (1) may have a configuration wherein, when the operation portion is in a switched off state, the operation portion does not project from the front surface or the back surface of the steering wheel.

(6) The embodiment described in (2) may have a configuration wherein, when the operation portion is in a switched off state, the operation portion does not project from the front surface or the back surface of the spoke portion.

(7) The embodiment described in (1) may have a configuration wherein, the operation portion includes a projecting portion that projects from the front surface or the back surface of the steering wheel when the operation portion is in a switched off state.

### Advantageous Effects of Invention

According to an embodiment of the present invention, a vehicle operation device can be provided for which the operational state such as the on/off state of a switch function can be easily discerned via touch or sight.

### BRIEF DESCRIPTION OF DRAWINGS

FIG. 1 is a perspective view illustrating a steering wheel of a vehicle in which an operation device for a vehicle according to an embodiment of the present invention is disposed.

FIG. 2 is a plan view illustrating the steering wheel when viewed from the driver side.

FIG. 3A is a cross-sectional view taken along line A-A of FIG. 2.

FIG. 3B is a perspective view illustrating an example configuration of a steering switch R.

FIG. 4A is a cross-sectional view illustrating the steering switch R (in a switched on state) mounted in an attachment hole portion of a spoke portion.

FIG. 4B is a cross-sectional view illustrating the steering switch R switched to on by a pressing operation on the front surface of the operation portion.

FIG. 4C is a cross-sectional view illustrating the steering switch R in the process of returning to a switched off state due to a pressing operation on the back surface of the operation portion.

FIG. 5 is a cross-sectional view illustrating a steering switch R (in a switched off state) according to a second embodiment mounted in an attachment hole portion of a spoke portion.

FIG. 6 is a block diagram illustrating a general configuration of a cruise control system for an embodiment of the present invention in which the steering switch R is applied to a cruise control switch.

FIG. 7A is a cross-sectional view taken along line B-B of FIG. 2 and illustrates an example arrangement in a steering wheel for an embodiment of the present invention in which the steering switch L is applied to an on/off operation switch for a speech recognition function.

FIG. 7B is a cross-sectional view taken along line B-B of FIG. 2 and illustrates a state of the steering switch L when the speech recognition function is turned off by the steering switch L being turned on.

### DESCRIPTION OF EMBODIMENTS

### Embodiments of Present Invention

According to an embodiment of the present invention, an operation device for a vehicle is a steering switch (steering switch R 10, steering switch L 20) mounted on a predetermined portion of a steering wheel 5. The steering switch is provided with an operation portion 12, 22 switchable via a tilt operation. When the operation portion 12, 22 is switched to on, a portion of the operation portion 12, 22 projects from a front surface 6a or a back surface 6b of the steering wheel 5.

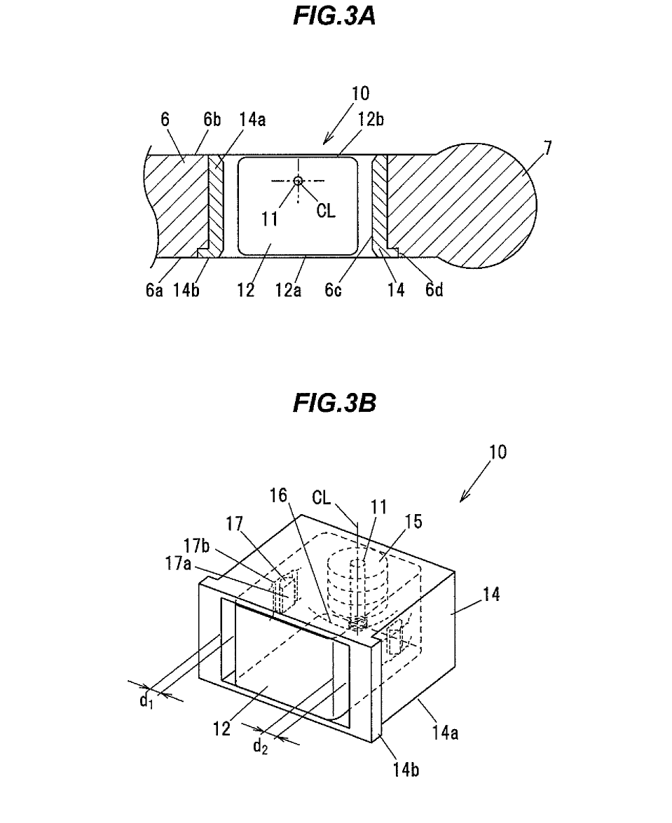

As illustrated in FIG. 3A, a predetermined portion of the steering wheel 5 may be a spoke portion 6 of the steering wheel 5, for example. Accordingly, the front surface 6a corresponds to the front surface of the spoke portion 6, and the back surface 6b corresponds to the back surface of the spoke portion 6. Note that a predetermined portion is required to be a position where the operation portion can be operated primarily with fingers when the driver grips a wheel portion 7 with his/her hands.

### First Embodiment

### Configuration of Steering Switch R 10

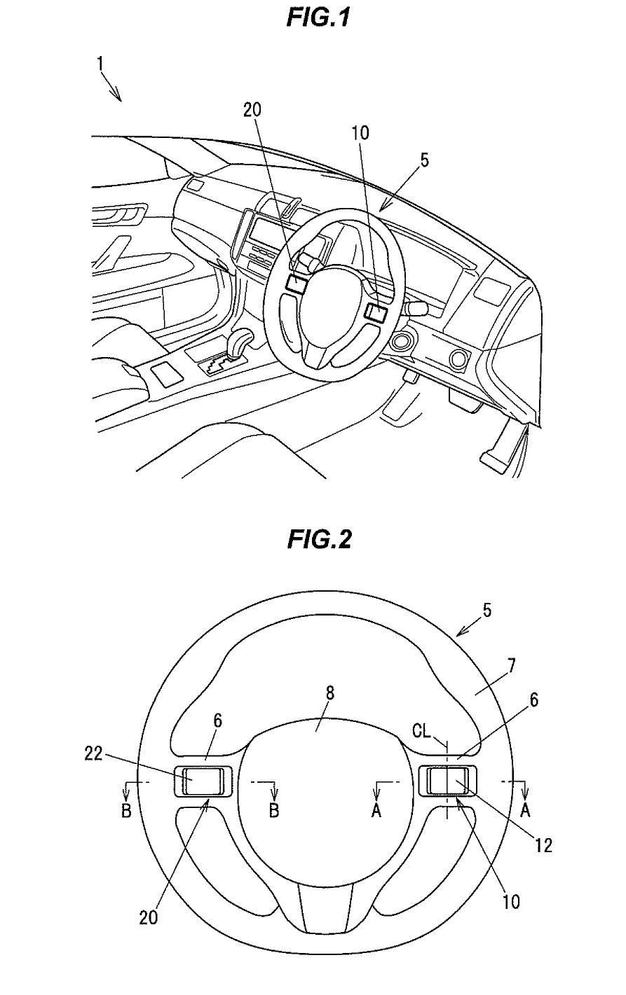

FIG. 1 is an overall perspective view of a region near the steering wheel 5 of a vehicle for explaining how the operation device for a vehicle according to an embodiment of the present invention is disposed. FIG. 2 is a plan view of the steering wheel 5 when viewed from the driver side. FIG. 3A is a cross-sectional view taken along line A-A of FIG. 2 and illustrates a portion of the steering switch R 10 and the spoke portion 6. FIG. 3B is a perspective view illustrating an example configuration of the steering switch R 10.

As illustrated in FIG. 1, the steering switch R 10 and the steering switch L 20, which are operation devices of a vehicle, are both mounted on the steering wheel 5 of a vehicle 1.

As illustrated in FIG. 2, the steering wheel 5 includes a boss portion 8 connected to a steering device of the vehicle 1, the wheel portion 7 that is gripped by the hands of a driver, and the spoke portions 6 that connect the boss portion 8 and the wheel portion 7.

The steering switch R 10 is mounted on the spoke portion 6 on the right side, and the steering switch L 20 is mounted on the spoke portion 6 on the left side. The steering switch R 10 and the steering switch L 20 are disposed at a location so to be operable primarily with fingers when the driver grips the wheel portion 7 with his/her hands. The steering switch R 10 and the steering switch L 20 are each required to be mounted on a predetermined portion of the steering wheel, which is a position where the steering switch R 10 and the steering switch L 20 are operable by a driver, however the mounting position is not limited to the spoke portion 6.

The steering switch R 10 is an operation device for a vehicle mounted on the spoke portion 6, which is a predetermined portion of the steering wheel 5 on the right side. In a similar manner, the steering switch L 20 is an operation device for a vehicle mounted on the spoke portion 6, which is a predetermined portion of the steering wheel 5 on the left side. The steering switch L 20 has a configuration and operation similar to that of the steering switch R 10, thus just the steering switch R 10 is described below.

The steering switch R 10, which is an operation device for a vehicle according to the first embodiment of the present invention, is mounted on a predetermined portion of the steering wheel 5 and includes the operation portion 12 switchable via an tilt operation. When the operation portion 12 is switched to on, a portion of the operation portion 12 projects from the front surface 6a or the back surface 6b of the steering wheel 5.

Here, “tilt operation” refers to the operation portion 12 being operated to rotate about a rotational shaft 11 in a range not greater than a predetermined angle. The rotation center of the operation portion 12 (tilt axis center) is not limited to being the center of the operation portion 12. Also, the front surface 6a of the steering wheel 5 faces the driver illustrated in FIG. 1, and the back surface 6b of the steering wheel 5 faces the traveling direction (forward direction) illustrated in FIG. 1.

FIG. 3A illustrates how the operation portion 12 housed in a housing is mounted on the spoke portion 6. FIG. 3B is a perspective view illustrating an example configuration of the steering switch R 10. In the explanation below, the operation portion 12 of the steering switch, which is an operation device for a vehicle, is housed in a housing 14 and supported in a manner allowing for tilt operation with respect to the rotational shaft 11. As illustrated in FIG. 3A, the housing 14 is attached to a predetermined portion of the steering wheel 5 by being inserted and mounted in an attachment hole portion 6c of the spoke portion 6. Note that in another embodiment, the operation portion 12 may be supported and mounted in a manner allowing for tilt operation in the spoke portion 6 without being supported by the housing 14.

As illustrated in FIG. 3A, the attachment hole portion 6c for mounting the housing 14 is formed in a predetermined portion of the steering wheel 5 as a through hole from the front surface 6a to the back surface 6b.

As illustrated in FIG. 3B, the housing 14 is a cylindrical housing capable of housing therein the operation portion 12 supported in a manner allowing for tilt operation with respect to the rotational shaft 11. The housing 14 includes a main body portion 14a that houses the operation portion 12 within, and a flange portion 14b that engages with a step portion 6d of the attachment hole portion 6c formed on the front surface 6a side of the spoke portion 6.

The operation portion 12 has six faces including a front operation face 12a disposed on the front surface 6a side of the spoke portion 6 and a back operation face 12b disposed on the back surface 6b side. The operation portion 12 is supported in the housing 14 in a manner allowing for tilt operation with respect to the rotational shaft 11, as described above. As illustrated in FIGS. 1 to 3A and 3B, the rotational shaft 11 is formed within the rotational plane of the steering wheel 5 and aligned with a CL direction substantially orthogonal to the longitudinal of the spoke portion 6.

In a neutral position, the front operation face 12a of the operation portion 12 is disposed substantially flush with the front surface 6a of the spoke portion 6. Alternatively, the front operation face 12a is disposed slightly recessed toward the inside of the housing from the front surface 6a of the spoke portion 6. Also, the back operation face 12b of the operation portion 12 is disposed substantially flush with the back surface 6b of the spoke portion 6. Alternatively, the back operation face 12b is disposed slightly recessed toward the inside of the housing from the back surface 6b of the spoke portion 6. In such a configuration, tilt operation of the operation portion 12 about the rotational shaft 11 makes a portion of the front operation face 12a of the operation portion 12 project from the front surface 6a of the spoke portion 6 and a portion of the back operation face 12b of the operation portion 12 project from the back surface 6b of the spoke portion 6.

Also, gaps d1, d2 between the operation portion 12 and the walls of the housing 14 illustrated in FIG. 3B are set to values allowing for tilt operation of the operation portion 12 within the housing 14. The gaps d1, d2 contribute to (visual) perceptibility of the steering switch R 10 being switched to on. Thus the gaps d1, d2 are set to values so that the (visual) perceptibility of the on operation, which is performed by operating the operation portion 12 to tilt the operation portion 12 within the housing 14 and change the gaps d1, d2, is improved. Note that the gap distance between the operation portion 12 and the walls of the housing 14 may differ depending on the direction (angle) of sight from the driver, thus the values of the gaps d1, d2 can differ or be the same.

As illustrated in FIG. 3B, inside the housing 14 and the operation portion 12, a switch portion 15 is provided centered about the rotational shaft 11. The switch portion 15 is a switch that switches to on/off via relative rotation of the housing 14 and the operation portion 12. Various switches can be employed, such as a contact switch, a magnetometric sensor and magnet, and a photointerrupter and light-blocking part.

As illustrated in FIG. 3B, inside the housing 14 and the operation portion 12, a return spring 16 is provided centered about the rotational shaft 11. The return spring 16 is a spring that is biased to return the operation portion 12 to the neutral position when the driver presses the operation portion 12 with his/her fingers to tilt (rotate) the operation portion 12. As illustrated in FIG. 3A, the neutral position is a position where the front surface 6a of the spoke portion 6 and the front operation face 12a of the operation portion 12 are parallel.

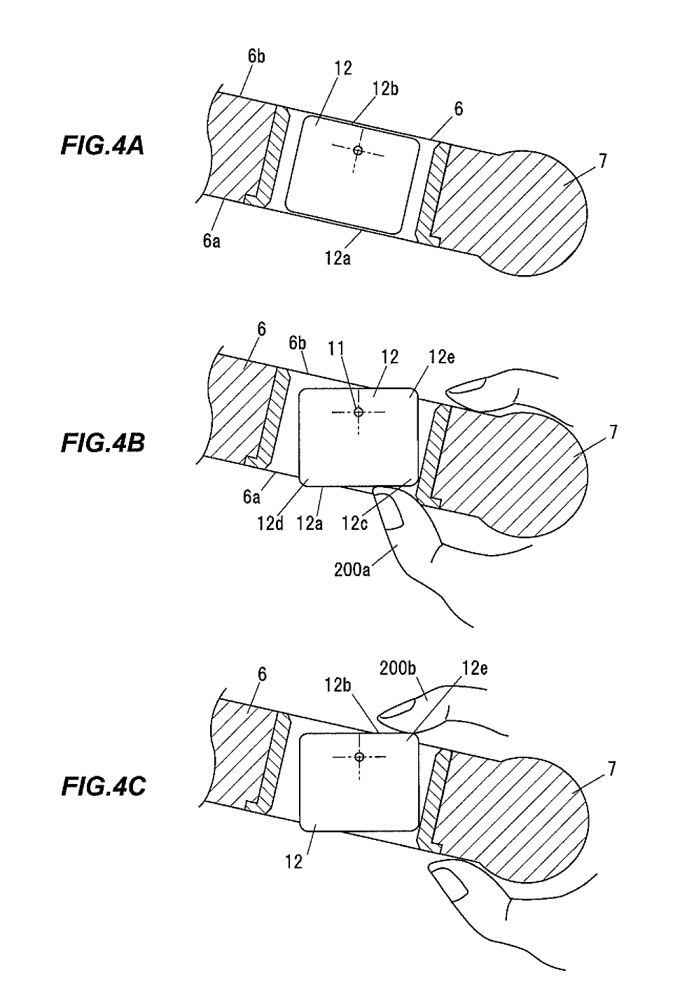

As illustrated in FIG. 3B, a detent portion 17 is provided between the housing 14 and the operation portion 12. The detent portion 17 includes, for example, a biased detent piece 17a disposed on the operation portion 12 and a groove portion 17b into which the tip of the detent piece 17a locks disposed on the housing 14 at two positions, one for the neutral position and one for the tilted position. This configuration allows the operation portion 12 to be held at two locking positions: the neutral position (off operation position), and the on operation position set by pressing and tilting the front operation face 12a of the operation portion 12. Note that in FIG. 4A and beyond, the detent portion 17 is omitted from the drawings.

Though omitted from the drawings, the detent portion 17 may also have a cyclic operation configuration in which with one press of the front operation face 12a of the operation portion 12, the operation portion 12 is held in the on operation position, and with another press of the front operation face 12a, the tip of the detent piece 17a and the groove portion 17b are released from their held state and the operation portion 12 returns to the neutral position (off position), urged by the return spring 16. For example, a configuration can be employed that incorporates known technology (technology used in retractable ballpoint pens for example) in which a cam mechanism enables the detent piece 17a to be alternately held and released by a tilt operation of the operation portion 12.

### Operation of Steering Switch R 10

FIG. 4A is a cross-sectional view illustrating the steering switch R (in a switched off state) mounted in the attachment hole portion of the spoke portion. FIG. 4B is a cross-sectional view illustrating the steering switch R switched to on by a pressing operation on the front surface of the operation portion. FIG. 4C is a cross-sectional view illustrating the steering switch R in the process of returning to a switched off state due to a pressing operation on the back surface of the operation portion.

The operation of switching the steering switch R 10 to on from the neutral position (off operation position) illustrated in FIG. 4A will be described. As illustrated in FIG. 4B, the driver gripping the wheel portion 7 with his/her fingers presses down the front right corner portion 12c of the operation portion 12 into the housing using a thumb 200a. This tilts the operation portion 12 with respect to the rotational shaft 11, and the operation portion 12 is held in the on operation position illustrated in FIG. 4B.

In the on operation position, the front left corner portion 12d of the operation portion 12 projects from the front surface 6a of the spoke portion 6. By a portion of the operation portion 12 projecting from the front surface 6a of the spoke portion 6, the on operational state of the steering switch R 10 can be easily visually discerned. Also, by the gaps d1, d2 between the operation portion 12 and the walls of the housing 14 illustrated in FIG. 3B changing, the on operational state of the steering switch R 10 can be easily visually discerned. Thus, the perceptibility when operating the operation portion 12 is improved.

When the operation portion 12 is in the on operation position, the front left corner portion 12d of the operation portion 12 projects from the front surface 6a of the spoke portion 6 and a back right corner portion 12e of the operation portion 12 projects from the back surface 6b of the spoke portion 6. By a portion of the operation portion 12 projecting from the front surface 6a and the back surface 6b of the spoke portion 6, the projecting portion can be easily felt with fingers, and via this tactile sensation, perceptibility is improved.

Next, the operation of switching the steering switch R 10 to off from the on operation position illustrated in FIG. 4B will be described. As illustrated in FIG. 4C, the driver gripping the wheel portion 7 with his/her fingers presses down the back right corner portion 12e of the operation portion 12 into the housing using an index finger 200b. This tilts the operation portion 12 with respect to the rotational shaft 11, and the operation portion 12 returns to the neutral position (off operation position).

As described above, in a configuration in which the on/off operation of the operation portion 12 is configured as a cyclic operation, when the operation portion 12 is in the on operation position illustrated in FIG. 4B, the tip of the detent piece 17a and the groove portion 17b are released from their held state by the front right corner portion 12c of the operation portion 12 being pressed down again into the housing by the thumb 200a, returning the operation portion 12 to neutral position (off position), urged by the return spring 16.

### Second Embodiment

FIG. 5 is a cross-sectional view illustrating a steering switch R (in a switched off state) according to a second embodiment mounted in an attachment hole portion of a spoke portion.

The steering switch according to the second embodiment has a configuration in which, when in the neutral position (off operation position), a portion of the operation portion 12, specifically a front left corner portion 12f of the operation portion 12, projects from the front surface 6a of the spoke portion 6. Except for this, the configuration and operation is similar to that of the first embodiment and thus description thereof is omitted. Such a configuration allows the projecting portion to be felt by fingers in the neutral position (off operation position), and the projecting amount can be used to easily distinguish between whether the operation portion 12 is in the neutral position (off operation position) or the on operation position. This configuration has the same effects as the first embodiment and can further improve the perceptibility via tactile sensation of the finger.

### Third Embodiment

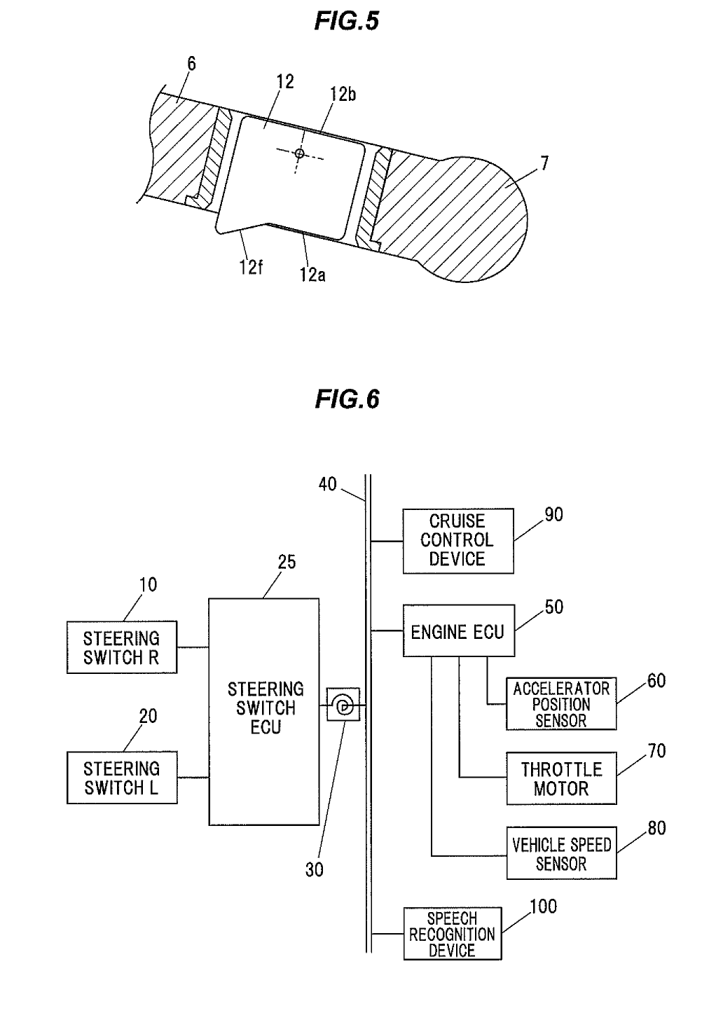

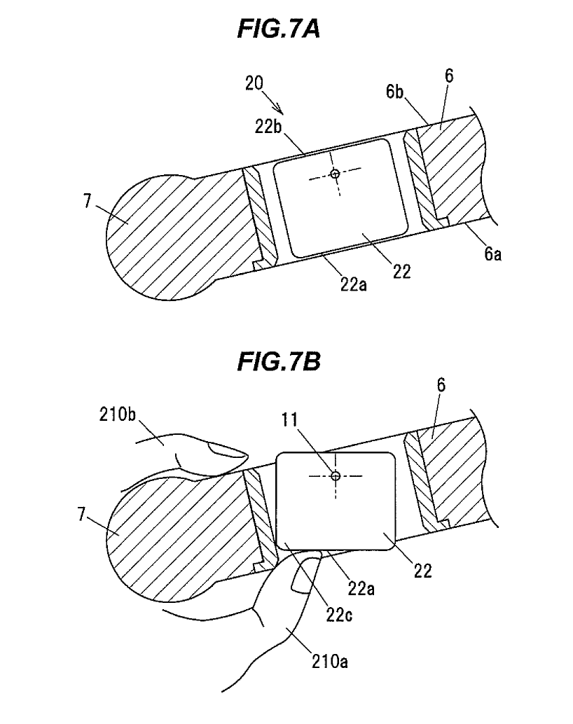

In the third embodiment, the steering switch R 10 is applied to a cruise control device. FIG. 6 is a block diagram illustrating a general configuration of a cruise control system for an embodiment of the present invention in which the steering switch R is applied to a cruise control switch.

Cruise control is, for example, a way of restricting the vehicle 1 to a certain speed so that the vehicle 1 maintains a set speed (set vehicle speed Vc).

As illustrated in FIG. 6, the steering switch R 10 and the steering switch L 20 are connected to a steering switch electronic control unit (ECU) 25, and connected to an onboard network 40 such as a local interconnect network (LIN) or a controller area network (CAN) via a steering roll connector 30. An engine ECU 50 and a cruise control device 90 are also connected to the onboard network 40, and cruise control can be activated/deactivated by the on/off operation of the steering switch R 10.

The engine ECU 50 is, for example, a computer unit including primarily a CPU, and also includes an input/output interface, a timer, a counter, and the like. Also, the engine ECU 50 is connected to various sensors such as a gear position sensor, a brake pedal sensor, a throttle position sensor, and the like, and the output values from these sensors are input into the engine ECU 50. The engine ECU 50 functions to regularly control the engine on the basis of an accelerator position Ac by performing concentrated control of the fuel injection system (electronic fuel injection (EFI)), ignition timing system (electronic spark advance ESA)), idle speed system (idle speed control (ISC)), and the like.

An accelerator position sensor 60 is attached to the accelerator pedal and detects the gradient of the magnetic field induced by the accelerator position (operated level) Ac via a magnetic detection element as an output voltage. The accelerator position sensor 60 outputs the detected accelerator position Ac to the engine ECU 50.

A vehicle speed sensor 80 includes, for example, a wheel speed sensor attached to each wheel and a skid control computer. The wheel speed sensor outputs a wheel speed pulse signal. The skid control computer converts the wheel speed pulse signal to a vehicle speed square-wave pulse signal (vehicle speed signal). The converted vehicle speed square-wave pulse signal is ultimately output to the engine ECU 50 as a vehicle speed V.

The cruise control device 90 acquires the vehicle speed V from the engine ECU 50 and the set vehicle speed Vc from the steering switch ECU 25 over the onboard network 40, and, on the basis of this information, controls the engine to run maintaining the set vehicle speed Vc. Cruise control involves adjusting primarily the rotation angle of a throttle motor 70 on the basis of a difference between the vehicle speed V acquired from the vehicle speed sensor 80 and the set vehicle speed Vc.

By switching the steering switch R 10 to on to turn on the main power source of the cruise control system, and only after confirming that the gear position is in a predetermined gear position, cruise control is activated. In other words, cruise control is activated by the front right corner portion 12c of the operation portion 12 being pressed down into the housing by the thumb 200a from the neutral position (off operation position) illustrated in FIG. 4A, to tilt the operation portion 12 to the on operation position illustrated in FIG. 4B.

In the on operation position, the front left corner portion 12d of the operation portion 12 projects from the front surface 6a of the spoke portion 6. By a portion of the operation portion 12 projecting from the front surface 6a of the spoke portion 6, the on operational state of the steering switch R 10 can be easily visually discerned. Also, by the gaps d1, d2 between the operation portion 12 and the walls of the housing 14 illustrated in FIG. 3B changing, the on operational state of the steering switch R 10 can be easily visually discerned. Thus, the on state of the cruise control system can be easily discerned via touch and sight, and perceptibility when the cruise control system is on is improved.

Control of cruise control is deactivated when: 1) the main power source of the cruise control system is turned off by an operation of the main switch; 2) the steering switch R 10 is switched to off; or 3) the brake pedal is operated to a predetermined level or greater.

In switching the steering switch R 10 to off, the following operations take place. As illustrated in FIG. 4C, the driver gripping the wheel portion 7 with his/her fingers presses down the back right corner portion 12e of the operation portion 12 into the housing using an index finger 200b. This tilts the operation portion 12 with respect to the rotational shaft 11, and the operation portion 12 returns to the neutral position (off operation position). The steering switch R 10 is switched to off, and cruise control is deactivated.

### Fourth Embodiment

In the fourth embodiment according to the present invention, a steering switch L 20 is mounted on the left side of the steering wheel 5 and has the function of turning speech recognition on and off. In other words, a portion of vehicle controls or control functions of the onboard devices often used while driving the vehicle are assigned to the steering switch.

In FIG. 6, a speech recognition device 100 is communicably connected to the steering switch L 20 over the onboard network 40. In a similar manner to that of the first to third embodiments, this configuration enables on/off control of the speech recognition device 100.

FIG. 7A is a cross-sectional view taken along line B-B of FIG. 2 and illustrates an example arrangement in the steering wheel for an embodiment of the present invention in which the steering switch L is applied to an on/off operation switch for a speech recognition function. FIG. 7B is a cross-sectional view taken along line B-B of FIG. 2 and illustrates a state of the steering switch L when the speech recognition function is turned off by the steering switch L being turned on.

The neutral position illustrated in FIG. 7A is the off position for the steering switch L 20, and the speech recognition device 100 is turned on in this operational state. In other words, the speech recognition function is on in the default state.

As illustrated in FIG. 7B, the driver gripping the wheel portion 7 with his/her fingers presses down a front left corner portion 22c of an operation portion 22 into the housing using a thumb 210a. This tilts the operation portion 22 with respect to the rotational shaft 11, and the operation portion 22 is held in the on operation position illustrated in FIG. 7B. The speech recognition device 100 is turned off in this operational state. In other words, the speech recognition function is turned off by operating the steering switch L 20 to switch it to on.

### Effects of Embodiments of Present Invention

(1) According to the first embodiment, in a neutral position (off operation position), the front operation face 12a of the operation portion 12 is disposed substantially flush with the front surface 6a of the spoke portion 6. Alternatively, the front operation face 12a is disposed slightly recessed toward the inside of the housing from the front surface 6a of the spoke portion 6. Also, the back operation face 12b of the operation portion 12 is disposed substantially flush with the back surface 6b of the spoke portion 6. Alternatively, the back operation face 12b is disposed slightly recessed toward the inside of the housing from the back surface 6b of the spoke portion 6. In the on operation position, tilt operation of the operation portion 12 about the rotational shaft 11 makes a portion of the front operation face 12a of the operation portion 12 project from the front surface 6a of the spoke portion 6 and a portion of the back operation face 12b of the operation portion 12 project from the back surface 6b of the spoke portion 6. By a portion of the operation portion 12 projecting from the front surface 6a of the spoke portion 6, the on operational state of the steering switch R 10 can be easily visually discerned. Also, by the gaps d1, d2 between the operation portion 12 and the walls of the housing 14 illustrated in FIG. 3B changing, the on operational state of the steering switch R 10 can be easily visually discerned. Thus, the perceptibility when operating the operation portion 12 is improved. Also, by the often used steering switch being able to be moved physically closer, operability is improved.

(2) According to the second embodiment, when the operation portion 12 is in the neutral position (off operation position), a portion of the operation portion 12, specifically a front left corner portion 12f of the operation portion 12, projects from the front surface 6a of the spoke portion 6. Such a configuration allows the projecting portion to be felt by a finger in the neutral position (off operation position), and the projecting amount can be used to easily distinguish between whether the operation portion 12 is in the neutral position (off operation position) or the on operation position. This configuration has the same effects as the first embodiment and can further improve the perceptibility via tactile sensation of the finger.

(3) According to the third embodiment in which a steering switch is applied to a cruise control switch, (visual and tactile) perceptibility of the on/off operational state of the cruise control switch, which is a switch important to driving safety, can be improved. This configuration allows driving safety to be improved. Also, the steering switch according to this embodiment of the present invention has future application to autonomous vehicles, and can contribute to the driving safety of such vehicles.

(4) According to the fourth embodiment, a steering switch can be attached to a discretionary position on the steering wheel 5 and various functions can be assigned to the steering switch. For example, the steering switch may be assigned the on/off function for speech recognition. By such an often used steering switch being able to be moved physically closer in a similar manner to that of the cruise control example, operability is improved.

(5) By assigning a steering switch according to another embodiment of the present invention various functions important to the driving of the vehicle, the operational state such as the on/off state of the function switch can be easily discerned via touch or sight, thus also providing effects of driving safety. Also, with such demands being expected to be raised for autonomous vehicles in the future, the steering switch according to an embodiment of the present invention can be effectively applied to autonomous vehicles.

Although several embodiments of the present invention have been described above, these embodiments are merely examples and the invention according to the claims is not to be limited thereto. These novel embodiments may be implemented in various other forms, and various omissions, substitutions, changes, and the like can be made without departing from the spirit and scope of the present invention. In addition, all the combinations of the features described in these embodiments are not necessarily needed to solve the technical problem. Further, these embodiments are included within the spirit and scope of the invention and also within the invention described in the claims and the scope of equivalents thereof.

### INDUSTRIAL APPLICABILITY

An embodiment of the present invention can be applied to an operation device for a vehicle such as a steering switch mounted on a steering wheel of a vehicle.

### REFERENCE SIGNS LIST

5 STEERING WHEEL
6 SPOKE PORTION
6a SURFACE
6b BACK SURFACE
6c ATTACHMENT HOLE PORTION
10 STEERING SWITCH R
12 OPERATION PORTION
14 HOUSING
20 STEERING SWITCH L
22 OPERATION PORTION

1. A vehicle operation device, comprising an operation portion mounted on a predetermined portion of a steering wheel, the operation portion allowing a switching operation to be performed by a tilt operation,
wherein when the operation portion is in an on state of the switching operation, a portion of the operation portion projects from a front surface and a back surface of the steering wheel.

2. The vehicle operation device according to claim 1, wherein the predetermined portion comprises a spoke portion of the steering wheel,
wherein the front surface comprises a front surface of the spoke portion, and
wherein the back surface comprises a back surface of the spoke portion.

3. The vehicle operation device according to claim 1, wherein, when the operation portion is in an off state of the switching operation, the operation portion does not project from the front surface and the back surface of the steering wheel.

4. The vehicle operation device according to claim 1, wherein, the operation portion is housed in a housing, and
wherein the housing is housed and mounted in an attachment hole portion, the attachment hole portion penetrating from the front surface to the back surface of the steering wheel.

5. The vehicle operation device according to claim 1, wherein, when the operation portion is in an off state of the switching operation, the operation portion does not project from the front surface and the back surface of spoke portion.

6. The vehicle operation device according to claim 2, wherein, when the operation portion is in an off state of the switching operation, the operation portion does not project from the front surface or the back surface of the spoke portion.

7. The vehicle operation device according to claim 1, wherein the operation portion comprises a projecting portion that projects from the front surface and the back surface of the steering wheel when the operation portion is in an off state of the switching operation.
